(19) United States
(12) Patent Application Publication
(10) Pub. No.: US 2009/0207239 A1
(43) Pub. Date: Aug. 20, 2009

(54) ARTIFICIAL EYE SYSTEM WITH DRIVE MEANS INSIDE THE EYE-BALL

(75) Inventors: Thomas Petrus Hendricus Warmerdam, Eindhoven (NL); Hubertus Cornelius Antonius Dirkx, Eindhoven (NL); Erik Johannes Antonius Manders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,062

(22) PCT Filed: Jun. 20, 2007
(86) PCT No.: PCT/IB2007/052370

§ 371 Date: Dec. 16, 2008

(30) Foreign Application Priority Data
Jun. 20, 2006 (EP) 06115718.6

(51) Int. Cl. H04N 7/18

(52) U.S. Cl. 348/61; 348/E07.085

(57) ABSTRACT

An artificial eye system, comprising at least one eye unit (2,3) having an eye-ball comprising a rotating spherical shell (7,19) and drive means for rotating said spherical shell (7,19) about its center. The drive means comprise a magnetic member (11) and electrical coils (12,13,14,15). The magnetic member (11) as well as the electrical coils (12,13,14,15) are located inside the rotating spherical shell (7,19).

The invention is related to an artificial eye system, comprising at least one eye unit having an eye-ball comprising a rotating spherical shell and drive means for rotating said spherical shell about its center, which drive means comprise a magnetic member and electrical coils. The expression ‘spherical’ means the shape of at least a part of a sphere or substantially a sphere, i.e. a globe with deviations from an exact sphere, which may be local deviations.

Such a system is disclosed in US-A-2003/0178901. This publication describes a camera system, whereby the camera unit comprises a spherical ball that can rotate in a socket having a concave supporting surface surrounding a portion of the spherical ball. In order to drive the rotational movement of the spherical ball, the surface of the ball is provided with a magnetic member, in the publication indicated as positioner. The concave supporting surface of the socket is provided with a large number of electrical coils. The rotational movement of the spherical ball is achieved by providing one or more of the coils with electric power causing a displacement of the positioner, i.e. the magnetic member.

The artificial eye system can be used as eyes in a toy (for example a doll) or in a robot (for example a household robot) or in any other device where one or more moving eyes, i.e. rotating eye-balls, are required. In many applications it is desired that the rotational movements of the eye-ball with respect to the structure that carries the rotating eye-ball (supporting structure) are relative quick, in particular in case the supporting structure itself is also moving. Rotational movements of a human eye can be very quick, and it is often desired that the rotational movement of the eye of a robot or of a doll or animal for entertainment purposes is as quick as the movement of a real human eye. For example, such quick movements are required to give the impression that the artificial eyes are following you and/or watching you.

The movement of the eye can be controlled by means of a camera that detects a moving “interesting object” in the visual field (field of view) of the camera. The interesting object can be selected according to the user's desire, such as an object with a certain color and/or a certain shape, for example a human face, a human hand, a figure, a car, etc. The camera can be fixed to the supporting structure that carries the rotating eye-ball or eye-balls, whereby the camera detects the direction of the interesting object. Thereby, the drive means of the eye-ball are controlled in such manner that the front side of the eye-ball is continue maintained in the direction of the detected interesting object.

In another application, the camera is mounted in the rotating eye-ball, whereby the drive means of the eye-ball are controlled in such manner that the interesting object is kept in the center of the field of view of the camera. Software for such application is available, as is for example described in US-A-2005/0185945.

An object of the invention is an artificial eye system, comprising at least one eye unit having an eye-ball with a rotating spherical shell and having drive means comprising a magnetic member and electrical coils, whereby the spherical shell of the eye-ball can rotate relative quick with respect to the supporting structure.

Another object of the invention is an artificial eye system, comprising at least one eye unit having an eye-ball with a rotating spherical shell and having drive means for rotating the eye-ball with respect to its supporting structure, whereby the dimensions of the eye unit, including the drive means, are relative small.

To accomplish with one or both of these objects, the magnetic member as well as the electrical coils are located inside the rotating spherical shell, i.e. inside the eye-ball which is partly bordered by the spherical shell. Thereby, an effective drive for the rotation of the spherical shell can be achieved, whereby all parts of the drive means can be located close to each other, so that they can be relative small, but nevertheless produce sufficient driving force in order to make quick movements.

Preferably, the axes of two electrical coils are directed substantially perpendicular with respect to each other in a plane substantially perpendicular with respect to the main direction of view of the eye unit. Thereby, the electrical coils can produce a desired magnetic field, depending on the electric current supplied to the coils, and the magnetic member will move with respect to the electrical coils according to the magnetic field. In that manner, the relative movement of the magnetic member with respect to the coils can be controlled.

In a preferred embodiment, the magnetic member is fixed to the structure that carries the rotating spherical shell, i.e. the structure that carries the eye-ball, and the electrical coils are fixed to the spherical shell. Thereby, the rotating portion of the eye-ball will have a relative small weight, because, in general, the weight of the electrical coils is less than the weight of the magnetic member. Thereby, preferably, the electrical coils are located in the center of the spherical shell, i.e. the center of the eye-ball, so that the moment of inertia of the rotating part of the eye-bal is relative low.

In another preferred embodiment, the electrical coils are fixed to the structure that carries the rotating spherical shell, and the magnetic member is fixed to the spherical shell and is located in the center of the spherical shell, i.e. the center of the eye-ball, so that the wires for supplying electric current to the coils interconnect stationary elements. Preferably, the magnetic member has a spherical shape. Thereby, the magnetic member will rotate with the spherical shell, but the moment of inertia is small, because the magnetic member rotates about its center.

Thereby, preferably, a piece of ferromagnetic material is positioned coaxially with respect to at least one of the electrical coils, at the opposite side of the magnetic member with respect to said electrical coil. Such piece of ferromagnetic material will intensify the magnetic field of the electrical coil at the location where the magnetic member is present. Of course, pieces of ferromagnetic material can also be used at other locations in order to influence the magnetic field.

In another preferred embodiment, the axis of two coaxial electrical coils is substantially perpendicular to the axis of two other coaxial electrical coils, whereby the magnetic member is located between both said two coaxial electrical coils. If the magnetic member is located in the center of the shell of the eye-ball, two small coaxial electrical coils can be present at both sides of the magnetic member inside said shell in order to create an appropriate magnetic field at the location of the magnetic member.

The rotating spherical shell of the eye-ball has to be attached to the supporting structure in such way that it can rotate about different axes. Various structures are available for such fixation of the spherical shell, however, in a preferred embodiment, the rotating spherical shell is attached to the supporting structure that carries the rotating shell by means of a gimbal mount, whereby the gimbal mount is located inside the spherical shell, i.e. inside the eye-ball.

Preferably, the gimbal mount comprises a gimbal ring, whereby the gimbal ring is rotating about a first axis with respect to the structure that carries the rotating spherical shell, i.e. the structure that carries the eye-ball, and whereby the gimbal ring is rotating about a second axis with respect to the rotating spherical shell, and whereby both axes extend perpendicular to each other in the plane of the gimbal ring. Thereby, the gimbal mount for supporting the rotating spherical shell as well as the drive means for rotating the spherical shell can be located inside the eye-ball. The gimbal mount will be further elucidated hereinafter when describing an embodiment of the invention.

A camera for detecting an interesting object in front of the eye system can be fixed to the supporting structure that carries the eye unit. Thereby, the location of the interesting object is detected and an electronic control system can rotate the spherical shell of the eye-ball in such manner that the eye is directed to the interested object. However, preferably, at least one camera is fixed in the rotating spherical shell of the eye-ball, whereby the spherical shell can be rotated in such manner that the camera keeps the interesting object in the center of its field of view. Relative small cameras are available, so that also two cameras can be mounted inside the eye-ball. Preferably, one camera is a wide angle camera and the other camera is a telephoto camera. The use and the control function of such two cameras in an eye system are described in US-A-2005/0185945.

In a preferred embodiment, means for detecting the position of the rotating spherical shell comprise four stator sensor parts fixed to the structure that carries the rotating spherical shell, whereby each stator sensor part has a concave spherical surface, and comprise a rotor sensor part fixed to the rotating spherical shell at the back side of the eye-ball and having a convex spherical surface, which spherical surface can move along portions of the spherical surfaces of the four stator sensor parts. Thereby, each of the four stator sensor parts can detect the degree of presence of the rotor sensor part near its concave surface, and based thereon the exact rotational position of the spherical shell of the eye-ball can be measured.

The rotating portion of the eye-ball can be balanced about its center, whereby the weight of the camera or cameras in front of the eye-ball is counterbalanced with the weight of the rotor sensor part at the back side of the spherical shell.

In order to accommodate electric wires for supplying electric current to the rotating eye-ball, openings can be present in the central portions of the rotor sensor part and of the four stator sensor parts, which openings have relative large dimensions, so that they overlap each other in each rotational position of the eye-ball.

The invention will now be further elucidated by means of a description of an embodiment of an artificial eye system comprising an eye-ball having a rotating spherical shell and drive means for rotating the spherical shell, whereby reference is made to the drawing comprising schematic perspective views, whereby:

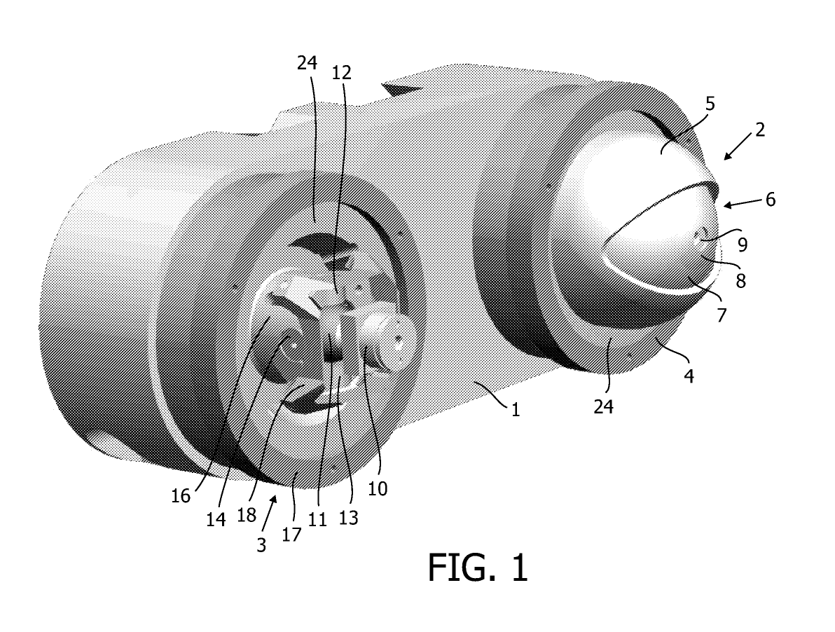

FIG. 1 is a perspective view of the eye system comprising two eye units,

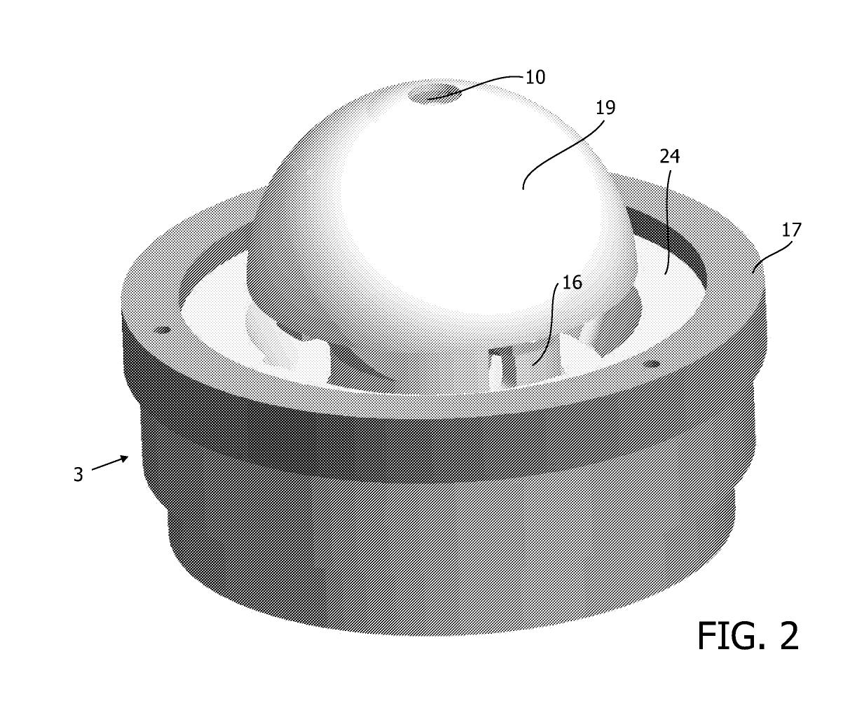

FIG. 2 shows the supporting structure with the rotating spherical shell,

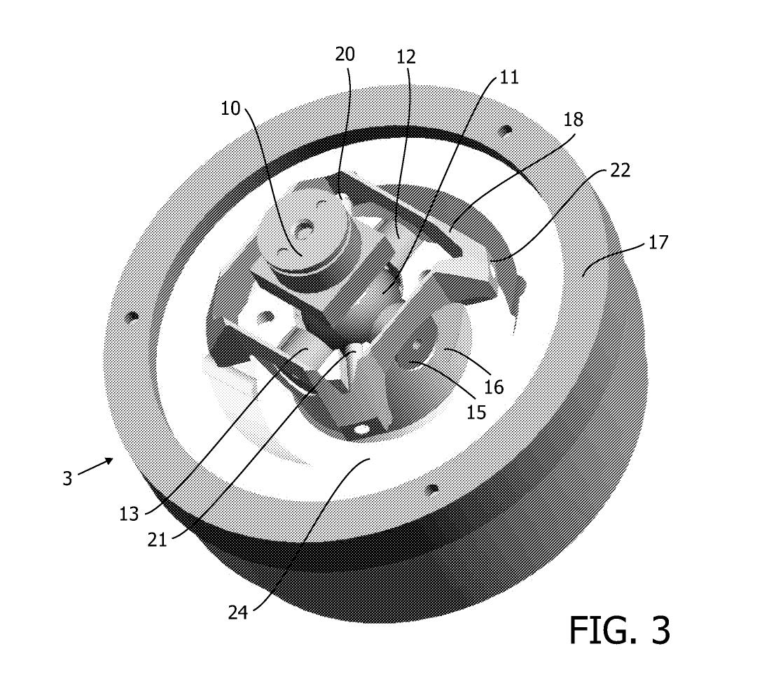

FIG. 3 shows different parts in the spherical shell of the eye-ball,

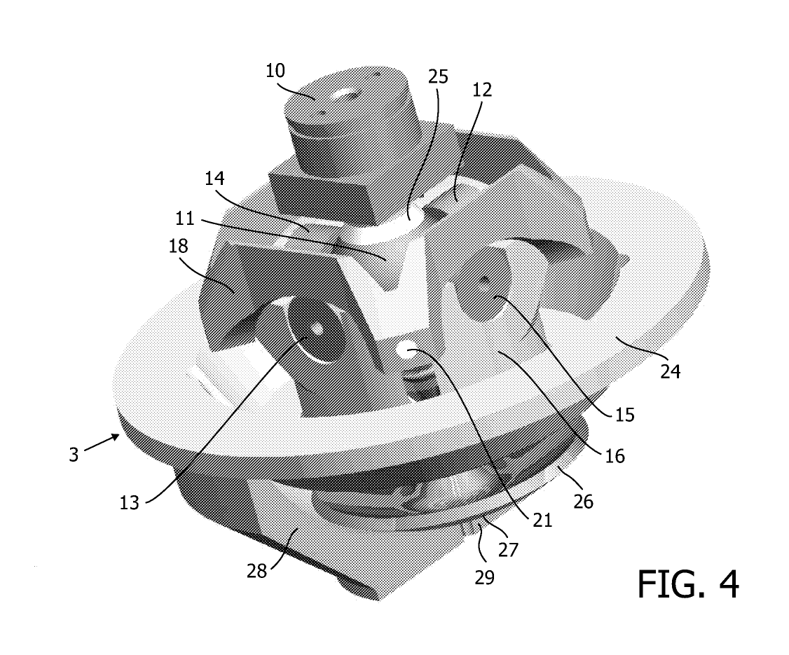

FIG. 4 is another view of parts of the eye-ball,

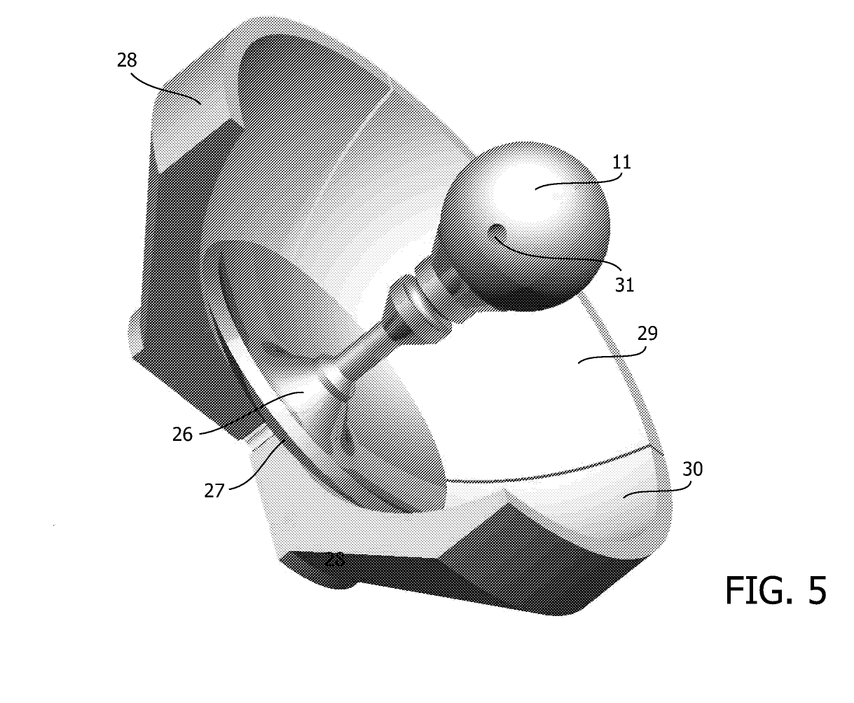

FIG. 5 shows the sensor for detecting the rotational position of the spherical shell, and

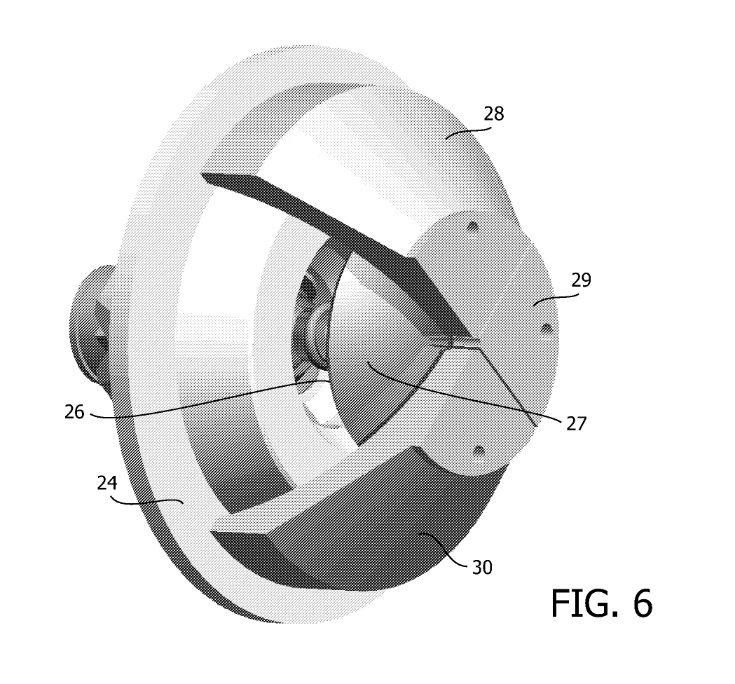

FIG. 6 shows the back side of that sensor.

The figures are only schematic representations of the embodiment of the eye system, whereby only those parts are shown that contribute to the elucidation of the invention.

FIG. 1 shows the eye system comprising a supporting structure 1 carrying two eye units 2,3. Eye unit 2 comprises a supporting ring 4, which supporting ring 4 is fixed to the supporting structure 1 by means of bolts (not shown) or the like. An annual part 24 is attached to the supporting ring 4, and a fixed eye-ball cover 5 is attached to the annual part 24. The fixed eye-ball cover 5 is a spherical shell with a relative large opening 6 at the front side of the eye unit 2. Inside the eye-ball cover 5 is a rotating spherical shell 7 having a relative small opening 8 at the front side of the eye unit 2. Inside the rotating spherical shell 7, and fixed to it, is a camera 9 viewing through said opening 8. By rotating the spherical shell 7 inside the fixed eye-ball cover 5, the eye unit 2 looks like a human eye having a rotating eye-ball in a fixed eyelid.

The eye unit 3 is shown in FIG. 1 without the fixed eye-ball cover 5 and without the rotating spherical shell 7 as is shown in the representation of the eye unit 2. Therefore, parts inside the rotating spherical shell of the eye-ball of eye unit 3 are represented in the figure. The rotating portion of the eye-ball comprises the camera 10 at the front side, and the rotating spherical shell of the eye-ball is attached to that camera 10. At its back side, the camera 10 is fixed to the magnetic member 11 located in the center of the eye-ball. The magnetic member 11 has a spherical surface and can rotate about its center, so that the camera 10, together with the spherical shell (not represented in eye unit 3), can be rotated into a desired position.

The rotating movement of the spherical magnetic member 11 is driven by four electrical coils 12,13,14,15. In FIG. 1 only three electrical coils 12, 13 and 14 are visible, electrical coil 15 is hidden behind the camera 10. All four electrical coils 12,13,14,15 are mounted in a support member 16, which support member 16 is fixed through the annual part 24 to the supporting ring 17. The two electrical coils 12 and 13 are positioned coaxially at opposite sides of the magnetic member 11, and the same applies for the two electrical coils 14 and 15. The axis of the two coaxial electrical coils 12 and 13 are positioned perpendicular to the axis of the two coaxial electrical coils 14 and 15, and both axes are located in a plane perpendicular to the main direction of view of the camera 10. By providing the four electrical coils 12,13,14,15 with electric current, the rotational position of the magnetic member 11 can be controlled, so that the direction of view of the camera 10 can be varied, together with the spherical shell (not shown in eye unit 3) that is fixed to the camera 10.

The magnetic member 11 is connected to the support member 16 by means of a so called gimbal mount, i.e. a structure giving rotational freedom about two perpendicular axes, for example used for a gyroscope or for a nautical compass. The gimbal mount comprises a gimbal ring 18. The gimbal ring 18 is connected to the support member 16 whereby it can rotate about a first axis with respect to the support member 16, and the gimbal ring 18 is connected to the magnetic member 11, and therewith to the rotating spherical shell, whereby it can rotate about a second axis with respect to the magnetic member 11. Both said axes are perpendicularly crossing each other.

FIG. 2 shows the eye unit 3 as shown in FIG. 1, whereby the spherical shell 19 is attached to the camera 10. The fixed eye-ball cover 5 which is represented in eye unit 2 in FIG. 1, is not present in FIG. 2. FIG. 2 also shows the annual part 24 being the connection between the supporting ring 17 and the support member 16.

FIG. 3 shows the eye unit 3 of FIG. 1, in a different perspective view. The figure shows the supporting ring 17, and the support member 16 is fixed thereto through the annual part 24. The support member 16 carries the four electrical coils 12,13,14,15; only three electrical coils 12,13,15 are visible in FIG. 3. The electric wires for supplying current to these four electrical coils 12,13,14,15 are not shown in the figures. Also the electric wires to the camera 10 are not represented.

The rotating magnetic member 11 is present between the electrical coils 12,13,14,15 and is connected with the support member 16 through the gimbal mount, comprising the gimbal ring 18. The gimbal ring 18 is connected to the magnetic member 11 through two coaxial pins 20,21 and can rotate about these pins 20,21 with respect to the magnetic member 11. The gimbal ring 18 is connected to the support member 16 by means of two coaxial pins 22,23, whereby only the end of pin 22 is visible in FIG. 3. The gimbal ring 18 can rotate about these pins 22,23 with respect to the support member 16. Due to this gimbal mount, the ball shaped magnetic member 11 can rotate with respect to the support member 16 about two perpendicular axes located in a plane, which plane is positioned perpendicular to the main direction of view of camera 10, which camera 10 is fixed to the magnetic member 11.

FIG. 4 shows the same eye unit 3 as is represented in FIG. 3, however, in a different perspective view, whereby the supporting ring 17 is deleted. The support member 16 is attached to the annular part 24, which annular part 24 can be attached to the supporting ring 17 (see FIG. 3). FIG. 4 shows all four electrical coils 12,13,14,15 that are fixed in the supporting member 16 and are surrounding the spherical magnetic member 11. Furthermore, connection member 25 is shown, connecting the camera 10 with the magnetic member 11.

As shown in FIG. 4, the rotating part of the eye unit 3 comprises a rotor sensor part 26 having the shape of an umbrella and being fixed to the back side of the magnetic member 11, i.e. the side opposite to the front side where the camera is attached. The rotor sensor part 26 has a convex spherical outer surface 27 having the same center as the magnetic member 11. When the magnetic member 11 rotates, the convex spherical outer surface 27 of the rotor sensor part 26 moves along the concave spherical surfaces of the four stator sensor parts 28,29,30 that are fixed to the annual part 24. In FIG. 4 only two stator sensor parts 28,29 are represented.

FIG. 5 shows the spherical magnet member 11 provided with a bore 31 for receiving the pin 21 (see FIG. 3), so that the magnetic member 11 can rotate about the axis of said pin 21. The umbrella shaped rotor sensor part 26 is fixed to the spherical magnetic member 11, so that the convex outer surface 27 of the rotor sensor part 26 is located near the concave surfaces of the stator sensor parts 28,29,30. Thereby, each of the four stator sensor parts detects the degree of presence of the rotor sensor part 26, so that the rotational position of the rotor sensor part 26, being the rotational position of the rotating spherical shell, can be measured. FIG. 5 shows three of the four stator sensor parts 28,29,30, but it will be clear that the fourth stator sensor part fits between the shown stator sensor parts 28,30 in order to form a concave spherical surface of almost a half globe.

FIG. 6 shows the same parts as represented in FIG. 5, but shown from the other side. The stator sensor parts 28,29,30 are shown from the back side, and the convex outer surface 27 of the rotor sensor part 26 is visible at the location where the fourth stator sensor part is deleted. The four stator sensor parts 28,29,30 are fixed to the annual part 24, which part 24 can be attached to the supporting ring 17 (see FIGS. 2 and 3).

The described embodiment of the artificial eye system is only an example of an eye system according to the invention; many other embodiments are possible.

1. An artificial eye system, comprising at least one eye unit (2,3) having an eye-ball with rotating spherical shell (7,19) and drive means for rotating said spherical shell (7,19) about its center, the drive means including a magnetic member (11) and electrical coils (12,13,14,15), wherein the magnetic member (11) and the electrical coils (12,13,14,15) are located inside the rotating spherical shell (7,19).

2. The eye system as claimed in claim 1, wherein axes of two electrical coils (12,14;13,15) are directed substantially perpendicular with respect to each other in a plane substantially perpendicular with respect to the main direction of view of the eye unit (2,3).

3. The eye system as claimed in claim 1, wherein the magnetic member (11) is fixed to the structure (1) that carries the rotating spherical shell (7,19), and the electrical coils are fixed to the spherical shell (7,19).

4. The eye system as claimed in claim 3, wherein the electrical coils are located in the center of the spherical shell (7,19).

5. The eye system as claimed in claim 1, wherein the electrical coils (12,13,14,15) are fixed to the structure (1) that carries the rotating spherical shell (7,19), and the magnetic member (11) is fixed to the spherical shell (7,19) and located in the center of the spherical shell (7,19).

6. The eye system as claimed in claim 5, wherein a piece of ferromagnetic material is positioned coaxially with respect to at least one of the electrical coils (12,13,14,15), at the opposite side of the magnetic member (11) with respect to said electrical coil.

7. The eye system as claimed in claim 5, wherein the axis of two coaxial electrical coils (12,13) is substantially perpendicular to the axis of two other coaxial electrical coils (14,15), such that the magnetic member (11) is located between said two coaxial electrical coils (12,13;14,15).

8. The eye system as claimed in claim 1, wherein the rotating spherical shell (7,19) is attached to the structure (1) that carries the rotating shell (7,19) by a gimbal mount, such that the gimbal mount is located inside the spherical shell (7,19).

9. The eye system as claimed in claim 8, wherein the gimbal mount comprises a gimbal ring (18), such that the gimbal ring (18) is rotating about a first axis with respect to the structure (1) that carries the rotating spherical shell (7,19) and the gimbal ring (18) is rotating about a second axis with respect to the rotating spherical shell (7,19), and the axes extend perpendicular to each other in the plane of the gimbal ring (18).

10. The eye system as claimed in claim 1, wherein at least one camera (9,10) is fixed in the rotating spherical shell (7,19).

11. The eye system as claimed in claim 1, wherein means for detecting the position of the rotating spherical shell comprise four stator sensor parts (28,29,30) fixed to the structure (1) that carries the rotating spherical shell (7,19), such that each stator sensor part (28,29,30) has a concave spherical surface, and comprise a rotor sensor part (26) fixed to the rotating spherical shell (7,19) at the back side of the eye-ball and having a convex spherical surface (27), such that the spherical surface (27) moves along portions of the spherical surfaces of the four stator sensor parts (28,29,30)
